(19) United States
(12) Patent Application Publication
(10) Pub. No.: US 2016/0226982 A1
(43) Pub. Date: Aug. 4, 2016

(54) LOCATION-BASED ASSOCIATED DATA MANAGEMENT METHODS AND SYSTEMS

(71) Applicant: Zappoint Corporation, Taipei City (TW)

(72) Inventor: Hsi-Tsun Chien, Taipei City (TW)

(21) Appl. No.: 15/006,173

(22) Filed: Jan. 26, 2016

(30) Foreign Application Priority Data
Jan. 29, 2015 (TW) 104102952

(51) Int. Cl. H04L 29/08; H04L 29/06

(52) U.S. Cl. CPC H04L 67/18; H04L 67/42

(57) ABSTRACT

Location-based associated data management methods and systems are provided. First, first data corresponding to a first location is provided in an electronic device. Then, a current location of the electronic device is obtained via a positioning unit of the electronic device. When the current location of the electronic device and the first location are not the same, second data corresponding to the current location for the first data is received by a network connecting unit via a network.

### BACKGROUND OF THE INVENTION

1. Field of the Invention

The disclosure relates generally to location-based associated data management methods and systems, and, more particularly to data transmission methods and systems that can provide associate data corresponding to specific data preset in an electronic device according to the specific data and a current location of the electronic device.

2. Description of the Related Art

Recently, electronic devices, such as smart phones, notebooks, wearable devices or other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

LBS (Location Based Service) has become a popular method for providing localized experiences for users. Generally, LBS integrates with the positioning capabilities of an electronic device to provide specific services and data to users that are related to the current location of the electronic device. For example, an electronic device may know a current location of the electronic device via a positioning unit, and obtain relevant store information nearby the electronic device according to the current location of the electronic device.

However, the conventional LBS simply provides related services or data according to the location of an electronic device. In other words, the conventional LBS does not consider the actual requirements of users. For example, when a user needs information about a specific store, and activates the LBS of an electronic device, the user always obtains information corresponding to a large number of stores including the specific store, and the user must spend additional time to locate the information about the specific store from the obtained information. In some cases, when the information about the specific store does not exist in the obtained information, the user still needs to spend time to discover this fact, resulting in poor user experience, and effecting the willingness of the user to continue using LBS.

### BRIEF SUMMARY OF THE INVENTION

Location-based associated data management methods and systems are provided, in which an electronic device can have specific data, and associated data corresponding to the specific data can be provided according to the current location of the electronic device.

In an embodiment of a location-based associated data management method, first data corresponding to a first location is provided in an electronic device. Then, a current location of the electronic device is obtained via a positioning unit of the electronic device. It is determined whether the current location of the electronic device is the first location. When the current location of the electronic device is not the first location, second data corresponding to the current location for the first data is received by a network connecting unit via a network.

An embodiment of a location-based associated data management system comprises a network connecting unit, a storage unit, a positioning unit, and a processing unit. The network connecting unit connects to a network. The storage unit stores first data corresponding to a first location. The positioning unit determines a current location of the electronic device. The processing unit determines whether the current location of the electronic device is the first location. When the current location of the electronic device is not the first location, the processing unit receives second data corresponding to the current location for the first data using the network connecting unit via the network.

In some embodiments, it is determined whether the second data corresponding to the current location for the first data exists. When the second data corresponding to the current location for the first data exists, the second data is received using the network connecting unit via the network. In some embodiments, it is determined whether the first data has a specific tag. When the first data has the specific tag, the first data and the current location of the electronic device are transmitted to a server using the network connecting unit via the network. The server determines whether the second data corresponding to the current location for the first data exists. When the second data corresponding to the current location for the first data exists, the server transmits the second data to the electronic device via a network.

In some embodiments, the determination of whether the current location of the electronic device is the first location is performed by determining whether the current location of the electronic device is within a predefined range of the first location. When the current location of the electronic device is within the predefined range of the first location, it is determined that the current location of the electronic device is the first location.

In some embodiments, the first data comprises information about a branch store of a chain enterprise at the first location, and the second data comprises information about a branch store of the chain enterprise at the current location.

In an embodiment of a location-based associated data management method, general data is provided in an electronic device. Then, a current location of the electronic device is obtained via a positioning unit of the electronic device. Localized data corresponding to the current location of the electronic device for the general data is provided.

An embodiment of a location-based associated data management system comprises a storage unit, a positioning unit, and a processing unit. The storage unit stores general data. The positioning unit determines a current location of the electronic device. The processing unit provides localized data corresponding to the current location of the electronic device for the general data.

In some embodiments, it is determined whether the localized data corresponding to the current location of the electronic device for the general data exists. When the localized data corresponding to the current location of the electronic device for the general data exists, the localized data is provided to the electronic device.

In some embodiments, the current location of the electronic device and the information about the general data are transmitted to a server using a network connecting unit via a network. The server obtains the localized data corresponding to the current location of the electronic device for the general data, and transmits the localized data to the electronic device via a network.

Location-based associated data management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed descriptions with references to the accompanying drawings, wherein:

FIG. 1 is a schematic diagram illustrating an embodiment of a location-based associated data management system of the invention;

FIG. 2 is a schematic diagram illustrating another embodiment of a location-based associated data management system of the invention;

FIG. 3 is a flowchart of an embodiment of a location-based associated data management method of the invention;

FIG. 4 is a flowchart of another embodiment of a location-based associated data management method of the invention;

FIG. 5 is a flowchart of another embodiment of a location-based associated data management method of the invention;

FIG. 6 is a flowchart of another embodiment of a location-based associated data management method of the invention; and

FIGS. 7A and 7B are schematic diagrams illustrating an example of location-based associated data of the invention.

### DETAILED DESCRIPTION OF THE INVENTION

Location-based associated data management methods and systems are provided.

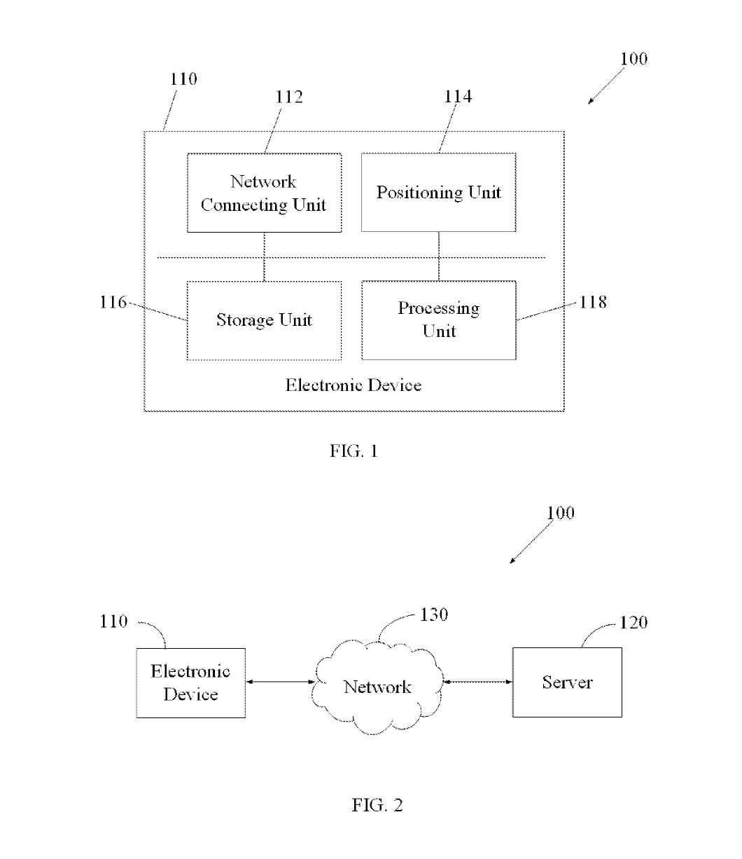

FIG. 1 is a schematic diagram illustrating an embodiment of a location-based associated data management system of the invention. The location-based associated data management system 100 can be used in an electronic device 110, such as a computer, or a portable device, such as a mobile phone, a smart phone, a PDA (Personal Digital Assistant), a GPS (Global Positioning System), a tablet, or a wearable electronic device. As shown in FIG. 1, the electronic device 110 comprises a network connecting unit 112, a positioning unit 114, a storage unit 116, and a processing unit 118. The network connecting unit 112 can be used to connect to a network, such as a wired network, a telecommunication network, and/or a wireless network. The electronic device 110 can have network connectivity capabilities by using the network connecting unit 112. The positioning unit 114 can be a GPS for communicating with at least one satellite to determine a location, such as a geographical location defined by longitude and latitude of the electronic device 110. The storage unit 116 can record location data of the electronic device 110 in specific time points. It is noted that, the storage unit 116 can store specific data (not shown in FIG. 1). The specific data corresponds to a specific location. It is understood that, in some embodiments, the specific data can comprise information about a branch store of a chain enterprise at the specific location. It is noted that, the specific data can exist in the electronic device 110 in any manner. For example, the specific data may be a paragraph of text, an e-business card, and/or a network link. It is noted that, the above specific data is only an example of the application, and the present invention is not limited thereto. The electronic device 110 can obtain the specific data via any manner. The processing unit 118 can control related operations of hardware and software in the electronic device 110, and perform the location-based associated data management method of the present invention, which will be discussed later. It is understood that, in some embodiments, the electronic device 110 can further comprise a display unit (not shown in FIG. 1) for displaying related information, such as images, interfaces and related data.

FIG. 2 is a schematic diagram illustrating another embodiment of a location-based associated data management system of the invention. The location-based associated data management system 100 can comprise at least one electronic device 110 and a server 120. The electronic device 110 can connect to the server 120 via a network 130. Similarly, the electronic device 110 may be a computer, or a portable device, such as a mobile phone, a smart phone, a PDA, a GPS, a tablet, or a wearable electronic device. The components of the electronic device 110 are similar to that in FIG. 1, and omitted here.

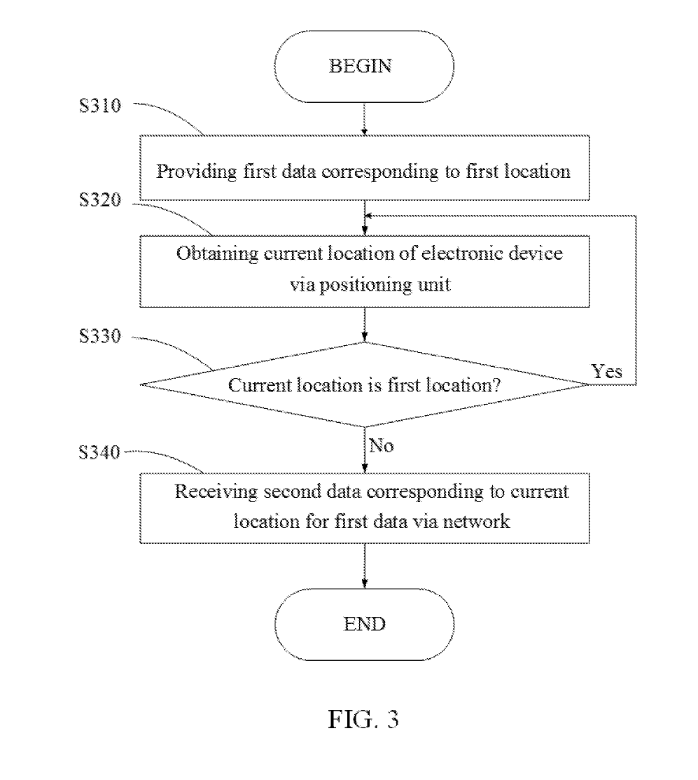

FIG. 3 is a flowchart of an embodiment of a location-based associated data management method of the invention. The location-based associated data management method can be used in an electronic device, such as a mobile phone, a smart phone, a PDA, a GPS, a tablet, or a wearable electronic device.

In step S310, first data corresponding to a first location is provided in the electronic device. It is understood that, in some embodiments, the first data can comprise information about a branch store of a chain enterprise at the first location. It is noted that, the electronic device 110 can obtain the first data via any manner, and the first data can exist in the electronic device 110 in any manner. For example, the first data may be a paragraph of text, an e-business card, and/or a network link. A user can store the text, collect the e-business card, or add the network link to website bookmarks to obtain the first data. It is noted that, the above first data is only an example of the application, and the present invention is not limited thereto. Then, in step S320, a current location of the electronic device is obtained via a positioning unit of the electronic device. It is understood that, in some embodiments, the electronic device can have a positioning unit, such as a GPS. The electronic device can obtain its location via the positioning unit. In step S330, it is determined whether the current location of the electronic device is the first location corresponding to the first data. It is understood that, in some embodiments, the determination of whether the current location of the electronic device is the first location is performed by determining whether the electronic device is within a predefined range of the first location according to the current location of the electronic device. When the electronic device is within the predefined range of the first location, it is determined that the current location of the electronic device is the first location. When the current location of the electronic device is the first location (Yes in step S330), the procedure returns to step S320. When the current location of the electronic device is not the first location (No in step S330), in step S340, second data corresponding to the current location for the first data is received by a network connecting unit of the electronic device via a network. It is understood that, in some embodiments, the second data can comprise information about a branch store of the chain enterprise at a second location (the current location of the electronic device). Similarly, the second data can exist in the electronic device 110 in any manner. It is understood that, in some embodiments, the second data can be displayed via a display unit of the electronic device 110.

It is understood that, in some embodiments, the electronic device or a server can determine whether the second data corresponding to the current location for the first data exists. When the second data corresponding to the current location for the first data exists, the electronic device can receive the second data using the network connecting unit via the network. In some embodiments, the electronic device or a server can determine whether general data exists for the first data. The general data comprises non-localized data of a chain enterprise, the first data comprises information about a branch store of the chain enterprise at a first location, and the second data comprises information about a branch store of the chain enterprise at a second location. It is noted that, an association exists between the general data, the first data, and the second data. When the general data exists for the first data, the electronic device can receive the general data using the network connecting unit via a network.

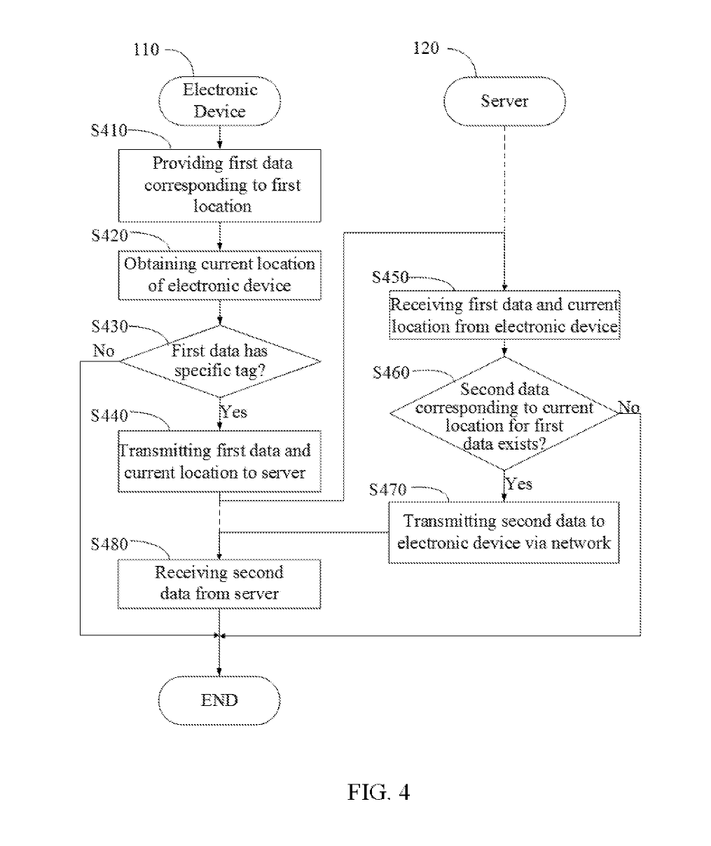

FIG. 4 is a flowchart of another embodiment of a location-based associated data management method of the invention. The location-based associated data management method can be used in a server 120 and an electronic device 110, such as a mobile phone, a smart phone, a PDA, a GPS, a tablet, or a wearable electronic device.

In step S410, first data corresponding to a first location is provided in the electronic device. Similarly, in some embodiments, the first data can comprise information about a branch store of a chain enterprise at the first location. It is noted that, the electronic device 110 can obtain the first data via any manner, and the first data can exist in the electronic device 110 in any manner. Then, in step S420, a current location of the electronic device is obtained via a positioning unit, such as a GPS of the electronic device. In step S430, it is determined whether the first data has a specific tag. It is noted that, the first data can be marked with the specific tag when other associated data exists for the first data. When the first data does not have the specific tag (No in step S430), the procedure is completed. When the first data has the specific tag (Yes in step S430), in step S440, the first data and the current location of the electronic device 110 are transmitted to the server 120 using a network connecting unit of the electronic device 110 via the network. It is understood that, in some embodiments, only the identification code corresponding to the first data is transmitted from the electronic device 110 to the server 120. It is understood that, in some embodiments, it is determined whether the current location of the electronic device 110 is the first location corresponding to the first data. In some embodiments, the determination of whether the current location of the electronic device is the first location is performed by determining whether the electronic device is within a predefined range of the first location according to the current location of the electronic device. When the electronic device is within the predefined range of the first location, it is determined that the current location of the electronic device is the first location. When the current location of the electronic device is the first location, step S440 is performed. In step S450, the server 120 receives the current location of the electronic device 110 and the first data or the identification code corresponding to the first data from the electronic device 110 via a network. Then, in step S460, it is determined whether second data corresponding to the current location for the first data exists. It is understood that, in some embodiments, the second data can comprise information about a branch store of the chain enterprise at a second location (the current location of the electronic device). Similarly, the second data can exist in the electronic device 110 in any manner. When the second data corresponding to the current location for the first data does not exist (No in step S460), the procedure is completed. When the second data corresponding to the current location for the first data exists (Yes in step S460), in step S470, the server 120 transmits the second data to the electronic device 110 via a network. In step S480, the electronic device 110 receives the second data from the server 120 using the network connecting unit via the network. Similarly, in some embodiments, the second data can be displayed via a display unit of the electronic device 110.

It is understood that, in some embodiments, the server can determine whether general data exists for the first data. The general data comprises non-localized data of a chain enterprise, the first data comprises information about a branch store of the chain enterprise at a first location, and the second data comprises information about a branch store of the chain enterprise at a second location. It is noted that, an association exists between the general data, the first data, and the second data. When the general data exists for the first data, the server transmits the general data to the electronic device via a network.

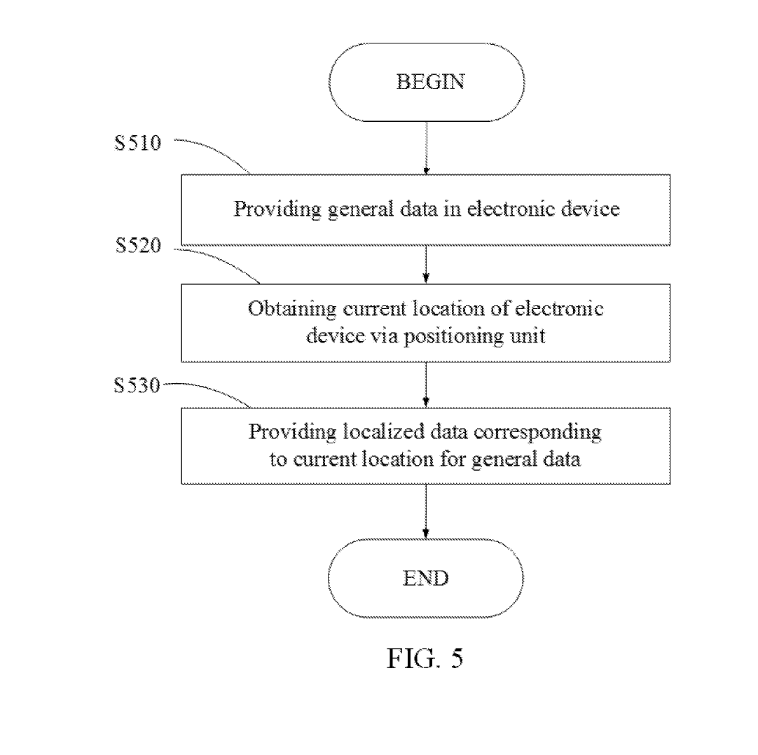

FIG. 5 is a flowchart of another embodiment of a location-based associated data management method of the invention. The location-based associated data management method can be used in an electronic device, such as a mobile phone, a smart phone, a PDA, a GPS, a tablet, or a wearable electronic device.

In step S510, general data is provided in the electronic device. It is understood that, in some embodiments, the general data comprises non-localized data of a chain enterprise. It is noted that, the chain enterprise also comprise localized data at different locations, such as information about branch stores. It is also noted that, an association exists between the general data and the localized data at different locations. It is understood that, the electronic device can obtain the general data via any manner, and the general data can exist in the electronic device in any manner. In step S520, a current location of the electronic device is obtained via a positioning unit, such as a GPS of the electronic device. In step S530, localized data corresponding to the current location of the electronic device for the general data is provided. As described, the localized data may comprise information about a branch store of the chain enterprise at the current location of the electronic device. Similarly, in some embodiments, the localized data can be displayed via a display unit of the electronic device.

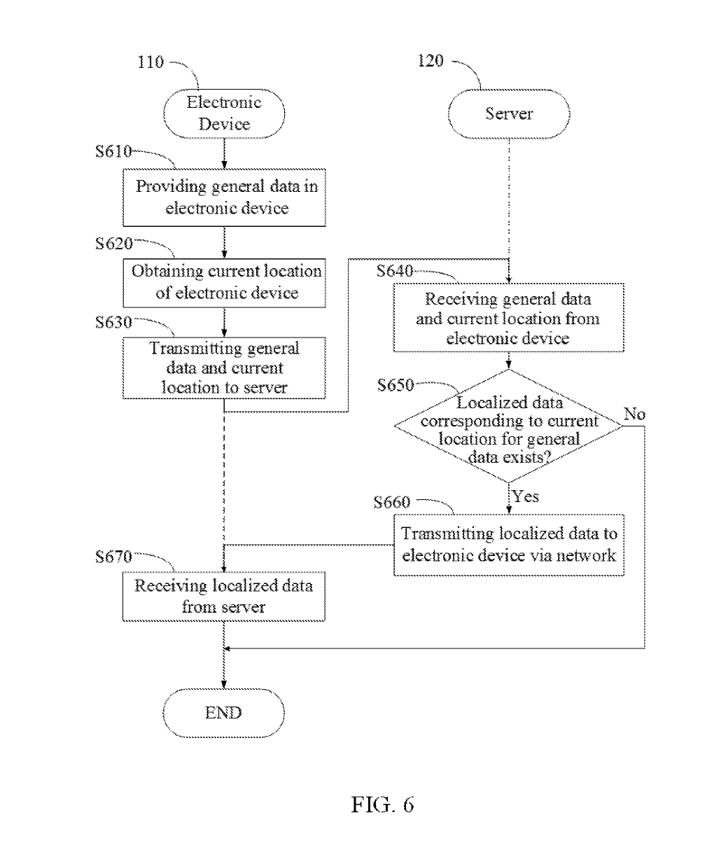

FIG. 6 is a flowchart of another embodiment of a location-based associated data management method of the invention. The location-based associated data management method can be used in a server 120 and an electronic device 110, such as a mobile phone, a smart phone, a PDA, a GPS, a tablet, or a wearable electronic device.

In step S610, general data is provided in the electronic device 110. It is understood that, in some embodiments, the general data comprises non-localized data of a chain enterprise. It is noted that, the chain enterprise also comprise localized data at different locations, such as information about branch stores. It is also noted that, an association exists between the general data and the localized data at different locations. It is understood that, the electronic device can obtain the general data via any manner, and the general data can exist in the electronic device in any manner. In step S620, a current location of the electronic device 110 is obtained via a positioning unit, such as a GPS of the electronic device 110. In step S630, the current location of the electronic device 110 and the information about the general data are transmitted to the server 120 using a network connecting unit of the electronic device 110 via a network. It is understood that, in some embodiments, only the identification code corresponding to the general data is transmitted from the electronic device 110 to the server 120. In step S640, the server 120 receives the current location of the electronic device 110 and the general data or the identification data corresponding to the general data from the electronic device 110 via a network. Then, in step S650, it is determined whether localized data corresponding to the current location of the electronic device for the general data exists. As described, the localized data may comprise information about a branch store of the chain enterprise at the current location of the electronic device. When the localized data corresponding to the current location of the electronic device for the general data does not exist (No in step S650), the procedure is completed. When the localized data corresponding to the current location of the electronic device for the general data exists (Yes in step S650), in step S660, the server 120 obtains the localized data, and transmits the localized data to the electronic device 110 via a network. In step S670, the electronic device 110 receives the localized data from the server 120 using the network connecting unit via a network. Similarly, in some embodiments, the localized data can be displayed via a display unit of the electronic device 110.

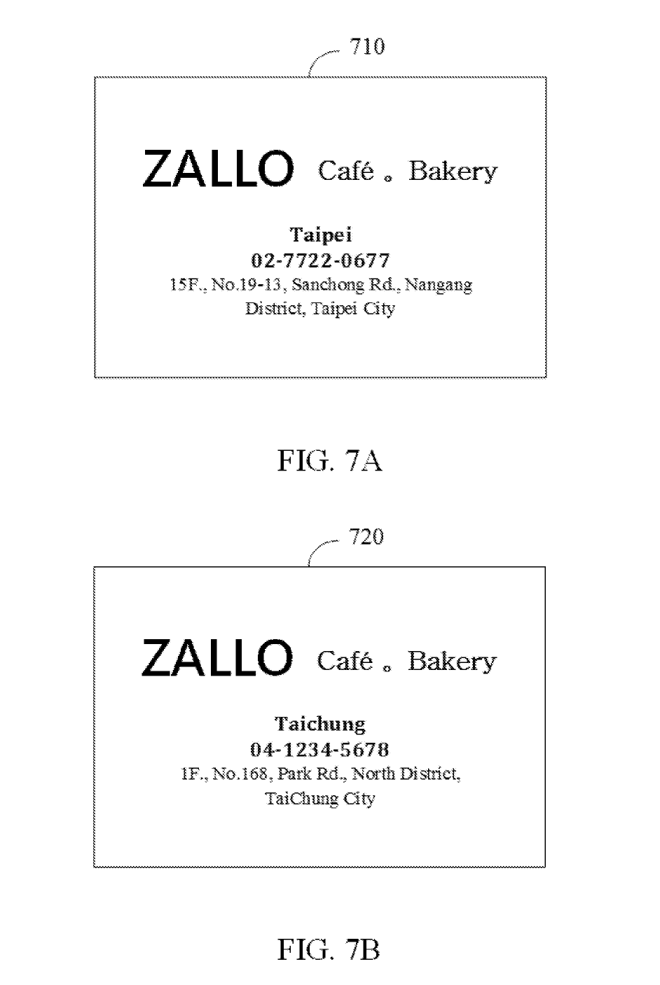

FIGS. 7A and 7B are schematic diagrams illustrating an example of location-based associated data of the invention. In the example, a user can use a smart phone to collect an e-business card 710 corresponding to a ZALLO cafe at Taipei, as shown in FIG. 7A. It is noted that, the e-business card 710 is the information about the branch store of the ZALLO cafe at Taipei. When the user travels to Taichung, the smart phone can detect the location of the device, and know the current location of the device is Taichung. Since the current location “Taichung” of the device and the location “Taipei” corresponding to the e-business card 710 are different, it is determined whether the ZALLO cafe has localized information about branch store at Taichung. When the localized information about branch store at Taichung exists, an e-business card 720 corresponding to the ZALLO cafe at Taichung, as shown in FIG. 7B is transmitted to the smart phone. It is noted that, only when the e-business card 710 already existed in the smart phone, the determination of whether the ZALLO cafe has localized information about branch store at Taichung is performed. In other words, when the e-business card 710 does not exist in the smart phone, the e-business card 720 will not be transmitted to the smart phone even if the user travels to Taichung.

Therefore, the location-based associated data management methods and systems of the present invention can provide associated data corresponding to specific data to an electronic device according to a current location of the electronic device and the specific data in the electronic device, thereby providing LBS by considering users' requirements, and enhancing the applicability and accuracy of LBS.

Location-based associated data management methods may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A location-based associated data management method for use in an electronic device, comprising:
providing first data corresponding to a first location in the electronic device;
obtaining a current location of the electronic device via a positioning unit of the electronic device;
determining whether the current location of the electronic device is the first location; and
when the current location of the electronic device is not the first location, receiving second data corresponding to the current location for the first data by a network connecting unit via a network.

2. The method of claim 1, further comprising:
determining whether the second data corresponding to the current location for the first data exists; and
when the second data corresponding to the current location for the first data exists, receiving the second data using the network connecting unit via the network.

3. The method of claim 2, further comprising:
determining whether the first data has a specific tag; and
when the first data has the specific tag, transmitting the first data and the current location of the electronic device to a server using the network connecting unit via the network,
wherein the server determines whether the second data corresponding to the current location for the first data exists, and when the second data corresponding to the current location for the first data exists, the server transmits the second data to the electronic device via a network.

4. The method of claim 1, wherein the determination of whether the current location of the electronic device is the first location is performed by determining whether the current location of the electronic device is within a predefined range of the first location, and when the current location of the electronic device is within the predefined range of the first location, it is determined that the current location of the electronic device is the first location.

5. The method of claim 1, wherein the first data comprises information about a branch store of a chain enterprise at the first location, and the second data comprises information about a branch store of the chain enterprise at the current location.

6. A location-based associated data management method for use in an electronic device, comprising:
providing general data in the electronic device;
obtaining a current location of the electronic device via a positioning unit of the electronic device; and
providing localized data corresponding to the current location of the electronic device for the general data.

7. The method of claim 6, further comprising:
determining whether the localized data corresponding to the current location of the electronic device for the general data exists; and
when the localized data corresponding to the current location of the electronic device for the general data exists, providing the localized data to the electronic device.

8. The method of claim 6, further comprising transmitting the current location of the electronic device and information about the general data to a server using a network connecting unit of the electronic device via a network, wherein the server obtains the localized data corresponding to the current location of the electronic device for the general data, and transmits the localized data to the electronic device via a network.

9. A location-based associated data management system for use in an electronic device, comprising:
a network connecting unit connecting to a network;
a storage unit comprising first data corresponding to a first location;
a positioning unit obtaining a current location of the electronic device; and
a processing unit determining whether the current location of the electronic device is the first location, and when the current location of the electronic device is not the first location, receiving second data corresponding to the current location for the first data by the network connecting unit via the network.

10. A location-based associated data management system for use in an electronic device, comprising:
a storage unit comprising general data;
a positioning unit obtaining a current location of the electronic device; and
a processing unit providing localized data corresponding to the current location of the electronic device for the general data.

11. A machine-readable storage medium comprising a computer program, which, when executed, causes a device to perform a location-based associated data management method, wherein the method comprises:
providing first data corresponding to a first location in the electronic device;
obtaining a current location of the electronic device via a positioning unit of the electronic device;
determining whether the current location of the electronic device is the first location; and
when the current location of the electronic device is not the first location, receiving second data corresponding to the current location for the first data by a network connecting unit via a network.

12. A machine-readable storage medium comprising a computer program, which, when executed, causes a device to perform a location-based associated data management method, wherein the method comprises:
providing general data in the electronic device;
obtaining a current location of the electronic device via a positioning unit of the electronic device; and
providing localized data corresponding to the current location of the electronic device for the general data.
